(19) United States
(12) Patent Application Publication
(10) Pub. No.: US 2006/0262289 A1
(43) Pub. Date: Nov. 23, 2006

(54) Zoomable projection apparatus

(76) Inventors: Hung-Chieh Huang, Chu-Nan (TW); Chih-Heng Fan Chiang, Chu-Nan (TW)

Correspondence Address: J.C. Patents, Inc., Suite 250, 4 Venture, Irvine, CA, 92618, US

(21) Appl. No.: 11/436,932

(22) Filed: May 17, 2006

(30) Foreign Application Priority Data
May 23, 2005 (TW) 94116654

(51) Int. Cl. G03B 27/54

(52) U.S. Cl. 355/67

(57) ABSTRACT

A zoomable projection apparatus including a projection system, an optical zoom adjusting device and a zoom ratio readout device is provided. The projection system at least includes a zoom lens set and an image control device. The optical zoom adjusting device is connected with the zoom lens set for adjusting an optical zoom ratio of the zoom lens set. The zoom ratio readout device can be connected to or disposed around the zoom lens set and is connected with the image control device for displaying the optical zoom ratio of the zoom lens set in an image projected by the projection system via the image control device.

### CROSS-REFERENCE TO RELATED APPLICATION

This application claims the priority benefit of Taiwan application serial no. 94116654, filed on May 23, 2005. All disclosure of the Taiwan application is incorporated herein by reference.

### BACKGROUND OF THE INVENTION

1. Field of the Invention

The present invention relates to a projection apparatus, and particularly to a zoomable projection apparatus.

2. Description of Related Art

Nowadays, accompanying with the advancement of the optical projection technology, projection apparatuses being able to output large images with high resolution and high definition have been developed and widely used. According to technical principles, the projection apparatuses can be divided into three categories: cathode ray tube (CRT) projection apparatuses, high-temperature polysilicon (HTPS) liquid crystal display (LCD) projection apparatus and digital light processing (DLP) projection apparatuses.

In recent years, the bulky and clumsy CRT projection apparatuses are gradually replaced by the LCD projection apparatuses and the DLP projection apparatuses. The LCD projection apparatuses and the DLP projection apparatuses are slim and portable, and they can even be directly connected to other digital products for projecting images. They are widely used in education, training, representations or meetings; they even become indispensable for providing visual images for home entertainment. Therefore, high image quality, high brightness, slimness, lightness and reasonable price are the important considerations for a consumer when purchasing a projection apparatus.

Although most of the projection apparatuses at present are zoomable, however, a user is not able to know the zoom ratio when operating. As a result, it is inconvenient for users.

### SUMMARY OF THE INVENTION

Accordingly, the object of the present invention is to provide a zoomable projection apparatus, being adapted for displaying the zoom ratio in the projection images when being operated.

For achieving the foregoing object and others, the present invention provides a zoomable projection apparatus. The projection apparatus includes a projection system, an optical zoom adjusting device and a zoom ratio readout device. The projection system at least includes a zoom lens set and an image control device. The optical zoom adjusting device is connected with the zoom lens set for adjusting an optical zoom ratio of the zoom lens set. The zoom ratio readout device is connected to or disposed around the zoom lens set, and is connected with the image control device for displaying the optical zoom ratio of the zoom lens set in an image projected by the projection system via the image control device.

According to an embodiment of the invention, the optical zoom adjusting device can be a stepping motor, being connected with the zoom ratio readout device.

According to an embodiment of the invention, the optical zoom adjusting device can be a stepping motor and the zoom ratio readout device can be an optical sensing module. The optical sensing module is disposed around the zoom lens set for sensing a relative position variation of the lenses inside.

According to an embodiment of the invention, the optical zoom adjusting device can be a manual adjusting means, being connected with the zoom ratio readout device.

According to an embodiment of the invention, the optical zoom adjusting device can be a manual adjusting means and the zoom ratio readout device can be an optical sensing module. The optical sensing module is disposed around the zoom lens set for sensing the position variation of the zoom lens set.

According to an embodiment of the invention, the image control device can be at least an LCD panel or a digital micro-mirror device (DMD).

According to an embodiment of the invention, the image control device can further display a digital zoom ratio in the image projected by the projection system.

According to an embodiment of the invention, the optical zoom ratio of the zoom lens set and the digital zoom ratio of the projection apparatus can either be respectively displayed or displayed as a whole after incorporated calculation.

In view of the above, the present invention employs the zoom ratio readout device for displaying the zoom ratio in the image projected by the projection system.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a zoomable projection apparatus according to a first embodiment of the invention.

FIGS. 2A to 2C are schematic diagrams respectively illustrating three zoom ratio adjusting interfaces of the first embodiment of the invention.

FIG. 3 is a block diagram illustrating a zoomable projection apparatus according to the second embodiment of the invention.

### DESCRIPTION OF THE EMBODIMENTS

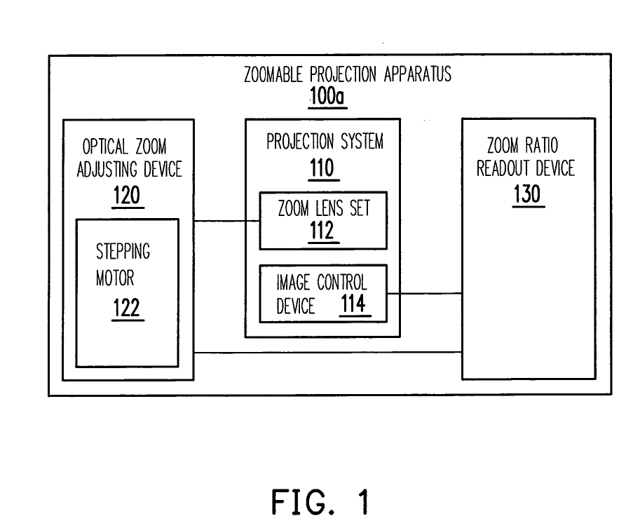

Referring to FIG. 1, a zoomable projection apparatus 100a of the embodiment includes a projection system 110, an optical zoom adjusting device 120 and a zoom ratio readout device 130. The projection system 110 includes at least a zoom lens set 112 and an image control device 114. The image control device 114 for example includes at least an LCD panel, a digital micro-mirror device (DMD) or other devices for determining the images to be projected according to externally inputted signals and then displaying the images to be projected on the projection image (not shown) of the projection system 110 via the zoom lens set 112. The image control device 114 is adapted for integrating, for example, data of an operation interface or a zoom ratio in the projection image. The optical zoom adjusting device 120 is connected to the zoom lens set 112 for adjusting the optical zoom ratio of the zoom lens set 112.

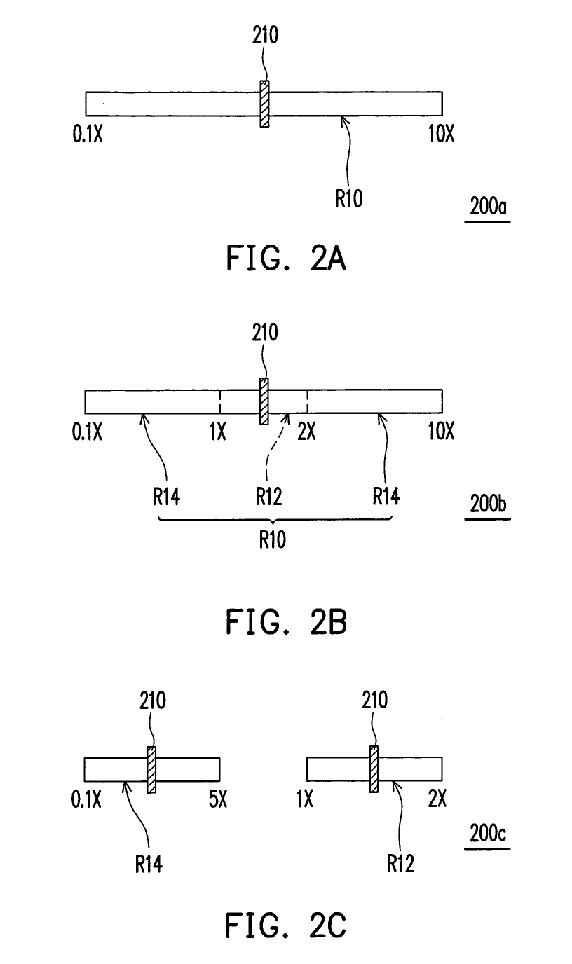

Further referring to FIG. 1, the optical zoom adjusting device 120 for example is a stepping motor 122. The zoom ratio readout device 130 is connected with the stepping motor 122 and the image control device 114 for calculating the optical zoom ratio according to the relative position variation between the internal lenses of the zoom lens set 112. Wherein, the internal lenses of the zoom lens set 112 are moved by the stepping motor 122 which receives a control signal. Thereafter the optical zoom ratio is transferred to the image control device 114. Final, the optical zoom ratio is displaying in the projection image projected by the projection system 110 via the optical control device 114. Furthermore, if the zoomable projection apparatus 100a has a digital zoom function, when the digital zoom function is activated, the digital zoom ratio can also be displayed in the projection image projected by the projection system 110 via the image control device 114. The optical zoom ratio and the digital zoom ratio can either be displayed as a whole after incorporated calculation (multiply these two items) or respectively displayed. Moreover, according to an aspect of the embodiment, the stepping motor 122 can be replaced by a manual adjusting means (not shown). In other words, a user can control the stepping motor 122 to adjust the optical zoom ratio of the zoom lens set 112 or directly adjust the optical zoom ratio of the zoom lens set 112 manually. During a process of adjusting the zoom ratio, the variation of the zoom ratio is displayed via a zoom ratio adjusting interface 200a (shown in FIG. 2A), by which the user can be aware of an instantly adjusted zoom ratio.

Referring to FIG. 2A, a zoom ratio adjusting interface 200a includes a cursor 210 and a zoom ratio display zone R10. The incorporate calculated zoom ratio of the optical zoom ratio and the digital zoom ratio is indicated in accordance with the cursor 210 moving within the zoom ratio display zone R10.

Referring to FIG. 2B, a zoom ratio adjusting interface 200b is similar to the zoom ratio adjusting interface 200a. The difference between the zoom ratio adjusting interfaces 200a and 200b is that the zoom ratio adjusting interface 200a is indicated according to the cursor 210 moving within the zoom ratio display zone R10 to mark the incorporate calculated zoom ratio of the optical zoom ratio and the digital zoom ratio; while according to the zoom ratio adjusting interface 200b, the zoom ratio display R10 is further divided into an optical zoom ratio display zone R12 and a digital zoom ratio display zone R14, by which the user can be aware of whether the digital zooming function is currently being used and be aware of the incorporate calculated zoom ratio of the optical zoom ratio and the digital zoom ratio according to the position of the cursor 210 in the zoom ratio display zone R10.

Referring to FIG. 2C, a zoom ratio adjusting interface 200c is similar to the zoom ratio adjusting interface 200b. The difference between the zoom ratio adjusting interfaces 200b and 200c is that the zoom ratio adjusting interface 200c has two individual zoom ratio display zones which are an optical zoom ratio display zone R12 and a digital zoom ratio display zone R14. Each of the zoom ratio display zones R12 and R14 has a cursor 210 for respectively indicating the optical zoom ratio and the digital zoom ratio.

The foregoing zoom ratio adjusting interfaces can be used in zoomable projection apparatuses, for example, a projector or a rear projection TV (RPTV), by which the users can be instantly aware of the current zoom ratio.

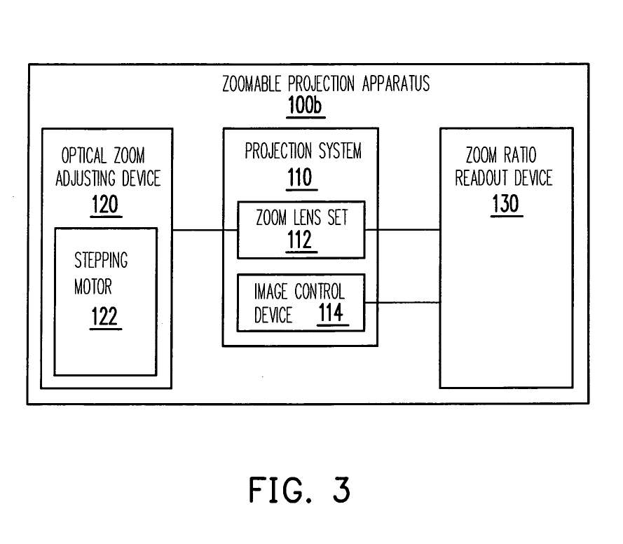

Referring to FIG. 3, the zoomable projection apparatus 100b is similar to the zoom able projection apparatus 100a provided by the first embodiment. The difference between the first embodiment and the second embodiment is that the zoom ratio readout device 130 of the first embodiment is connected to a stepping motor 122 for obtaining the relative position variation between the internal lenses of the zoom lens set 112 From the control signals received by the stepping motor 122, by which the optical zoom ratio can be calculated; while the zoom ratio readout device 130 of the second embodiment is an optical sensing module 132 and disposed around the zoom lens set 112 for sensing the relative position variation between the internal lenses of the zoom lens set 112, by which the optical zoom ratio can be calculated.

In view of the above, the present invention provides a zoomable projection apparatus having a function of instantly displaying the zoom ratio on a projection image when operating, by which the user can be instantly aware of the current zoom ratio from the projection image when operating such a zoomable projection apparatus.

It should be noted that specific embodiments of and examples for, the invention are described herein for illustrative purposes, various equivalent modifications are possible within the scope of the invention, as those skilled in the relevant art will recognize that modifications and adaptations of the above-described preferred embodiments of the present invention may be made to meet particular requirements. This disclosure is intended to exemplify the invention without limiting its scope. All modifications that incorporate the invention disclosed in the preferred embodiment are to be construed as coming within the scope of the appended claims or the range of equivalents to which the claims are entitled.

What is claimed is:

1. A zoomable projection apparatus, comprising:
a projection system, at least comprising a zoom lens set and an image control device;
an optical zoom adjusting device, being connected with the zoom lens set for adjusting an optical zoom ratio of the zoom lens set; and
a zoom ratio readout device, being connected to or disposed around the zoom lens set and being connected with the image control device for displaying the optical zoom ratio of the zoom lens set in an image projected by the projection system via the image control device.

2. The zoomable projection apparatus according to claim 1, wherein the optical zoom adjusting device comprises a stepping motor being connected with the zoom ratio readout device.

3. The zoomable projection apparatus according to claim 1, wherein the optical zoom adjusting device comprises a stepping motor and the zoom ratio readout device comprises an optical sensing module, the optical sensing module being disposed around the zoom lens set for sensing a relative position variation of the lenses inside.

4. The zoomable projection apparatus according to claim 1, wherein the optical zoom adjusting device comprises a manual adjusting means being connected with the zoom ratio readout device.

5. The zoomable projection apparatus according to claim 1, wherein the optical zoom adjusting device comprises a manual adjusting means and the zoom ratio readout device comprises an optical sensing module, the optical sensing module being disposed around the zoom lens set for sensing the position variation of the zoom lens set.

6. The zoomable projection apparatus according to claim 1, wherein the image control device further displays a digital zoom ratio in the image projected by the projection system.

7. The zoomable projection apparatus according to claim 6, wherein the optical zoom ratio of the zoom lens set and the digital zoom ratio of the projection apparatus are respectively displayed.

8. The zoomable projection apparatus according to claim 6, wherein the optical zoom ratio of the zoom lens set and the digital zoom ratio of the projection apparatus are displayed as a whole after incorporated calculation.

9. The zoomable projection apparatus according to claim 1, wherein the image control device comprises at least a liquid crystal display panel.

10. The zoomable projection apparatus according to claim 1, wherein the image control device comprises at least a digital micro-mirror device.
